(19) United States
(12) Patent Application Publication
(10) Pub. No.: US 2016/0303584 A1
(43) Pub. Date: Oct. 20, 2016

(54) Irrigation Sprinkler

(71) Applicant: YUAN MEI CORP., Lugang Township (TW)

(72) Inventor: Shun-Nan LO, Lugang Township (TW)

(21) Appl. No.: 15/068,161

(22) Filed: Mar. 11, 2016

Related U.S. Application Data
(63) Continuation-in-part of application No. 14/685,606, filed on Apr. 14, 2015.

(51) Int. Cl. B05B 1/30; B05B 1/16; A01G 25/00

(52) U.S. Cl. CPC B05B 1/30; A01G 25/00; B05B 1/16

(57) ABSTRACT

An irrigation sprinkler includes an engagement component connecting a cap component to a base by a converging movement. The base includes a holding member; the cap component includes an anchor member; and the engagement component includes a first male member and a first female member mating with each other. The first male member is alternatively arranged on the holding member and the anchor member, and the first female member is arranged on the other. Therefore, the first male member non-releasably couples with the first female member by a movement toward each other, and the first engagement component connects the cap component to the base. An indication component couples with the cap component offers visual recognition of the selected one of nozzles.

### CROSS-REFERENCE TO RELATED APPLICATION

This application is a continuation in part of U.S. patent application Ser. No. 14/685606 filed on Apr. 14, 2015 entitled “ABOVE GROUND SPRINKLER”, the content of which is hereby incorporated by reference in its entirety.

### BACKGROUND OF THE INVENTION

1. Technical Field

The present invention relates to a sprinkler, specifically to an irrigation sprinkler with multiple selectable nozzles.

2. Background of the Invention

For irrigation sprinkler, it is known to arrange multiple nozzles on a head which can be rotated to align one of the nozzles with the water inlet

US Patent No. U.S. Pat. No. 7,090,146 B1, titled “Above-Ground Adjustable Spray Pattern Sprinkler”, discloses an above-ground sprinkler having a head that rotates about an angle determined by the relative angles between a pair of arc adjustment rings.

The head further includes a cover and a flow control member. The flow control member is attached to the cover by an attachment screw, so that the flow control member could rotate about the attachment screw for allowing the user to select any nozzle with ease. However, the application of the attachment screw complicates the assembly step. In addition, the sprinkler offers no simple visual indication to which nozzle is being selected or the direction of the spray. For clarity, “cover” will henceforth be referred as “base” and “flow control member” will henceforth be referred as “nozzle assembly”.

In the interest of assembly economic and user friendliness, a sprinkler which can be fabricated straightforward and assembled with easy manipulation is desired.

### SUMMARY

It is therefore for one or more aspects to provide an irrigation sprinkler of convenient assembly without screws.

It is therefore for one or more aspects to provide an irrigation sprinkler of easy manipulation for users fully grasping the irrigation sprinkler from top to rotate a nozzle assembly of the irrigation sprinkler.

It is therefore for one or more aspects to provide an irrigation sprinkler with visual identification for users recognizing the selected nozzle.

To achieve the present disclosure mentioned above, an irrigation sprinkler, adapted for connecting to a water source, is disclosed. The irrigation sprinkler includes a base, a nozzle assembly, a cap component, a first engagement component, and an indication component. The base defines an orifice communicating with the water source, and includes a holding member disposed thereon. The nozzle assembly slideably attaches to the base and is capable of rotating around a generally vertical axis of the base; the nozzle assembly defines a passage through which the holding member of the base penetrates; the nozzle assembly further defines a plurality of nozzles circumferentially arranged thereof and spaced apart. The cap component sits over the base and the nozzle assembly; the cap component includes an anchor member disposed thereof. The first engagement component includes a first male member and a first female member; the first male member is alternatively arranged on the holding member of the base and the anchor member of the cap component, and the first female member is arranged on the other; the first male member non-releasably couples with the first female member by a converging movement between the holding member and the anchor member, and the first engagement component connects the cap component to the base. The nozzle assembly is thereby restrained from vertical movement. The indication component couples with the cap component and corresponds to the orifice of the base. As a rotation of the nozzle assembly takes place, the indication component aligns a selected one of the nozzles, which communicates with the orifice of the base, and offers visual recognition of the selected one of the nozzles.

Other advantages and features of the present disclosure will be fully understood by reference to the following specification in conjunction with the accompanying drawings, in which like reference signs denote like components of structure.

### BRIEF DESCRIPTION OF THE DRAWINGS

FIG. 1 is an explosion view illustrating an irrigation sprinkler in accordance to a first embodiment of the present disclosure;

FIG. 2 is a perspective view illustrating parts in FIG. 1;

FIG. 3 is an explosion view with partial assembly according to FIG. 1;

FIG. 4 is a cross-sectional profile in accordance to first embodiment of the present disclosure;

FIG. 5 is another cross-sectional profile in accordance to first embodiment of the present disclosure;

FIG. 6 is a perspective view in illustrating an irrigation sprinkler in accordance to a second embodiment of the present disclosure;

FIG. 7 is an explosion view in a top perspective illustrating an irrigation sprinkler in accordance to the second embodiment of the present disclosure;

FIG. 8 is an explosion view in a bottom perspective illustrating an irrigation sprinkler in accordance to the second embodiment of the present disclosure;

FIG. 9 is a perspective view in illustrating an irrigation sprinkler in accordance to a third embodiment of the present disclosure;

FIG. 10 is an explosion view in a top perspective illustrating an irrigation sprinkler in accordance to the third embodiment of the present disclosure;

FIG. 11 is an explosion view in a bottom perspective illustrating an irrigation sprinkler in accordance to the third embodiment of the present disclosure;

FIG. 12 is an explosion view in a top perspective illustrating an irrigation sprinkler in accordance to a fourth embodiment of the present disclosure;

FIG. 13 is an explosion view in a bottom perspective illustrating an irrigation sprinkler in accordance to the fourth embodiment of the present disclosure;

FIG. 14 is a perspective view in illustrating an irrigation sprinkler in accordance to a fifth embodiment of the present disclosure;

FIG. 15 is an explosion view in a top perspective illustrating an irrigation sprinkler in accordance to the fifth embodiment of the present disclosure; and

FIG. 16 is an explosion view in a bottom perspective illustrating an irrigation sprinkler in accordance to the fifth embodiment of the present disclosure.

### DETAILED DESCRIPTION

The present disclosure relates to an irrigation sprinkler 100 adapted for connecting to a water source. The irrigation sprinkler 100 according to the embodiments of the present disclosure will be described with reference to the drawings. Repeated description thereof may be omitted.

### First Embodiment

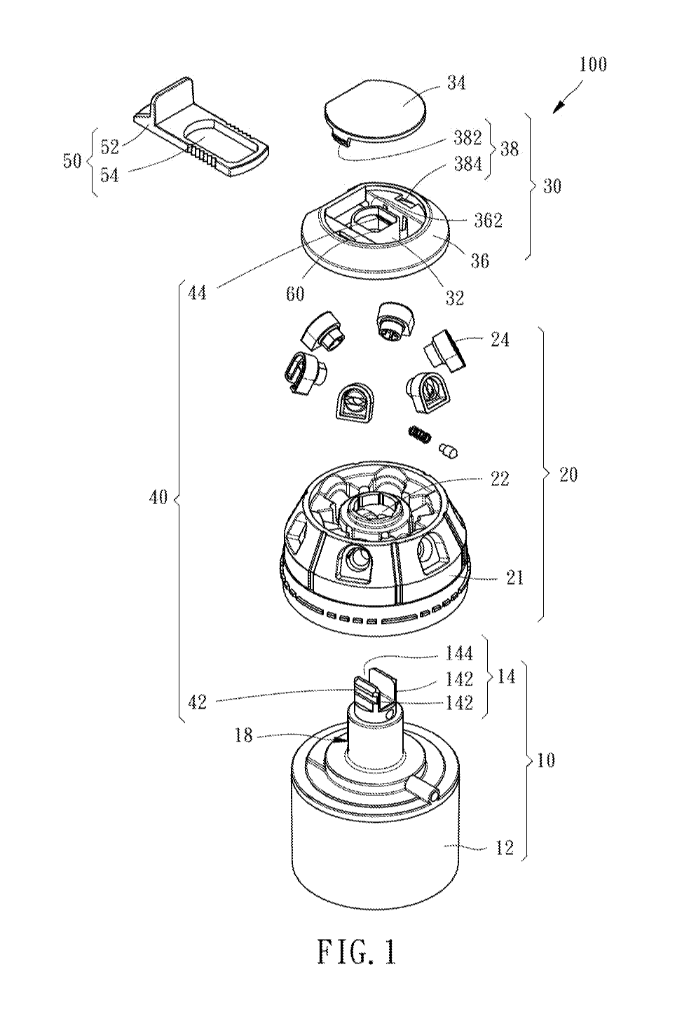

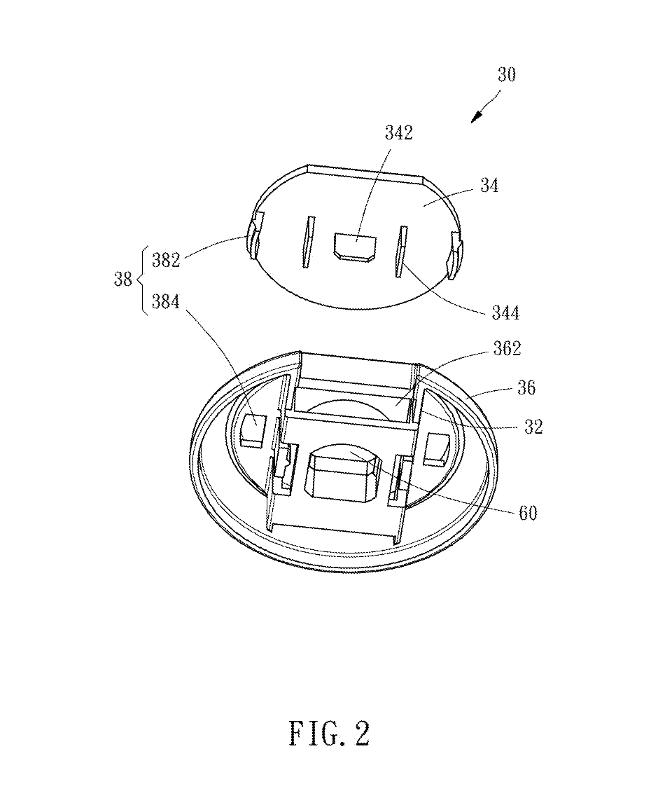

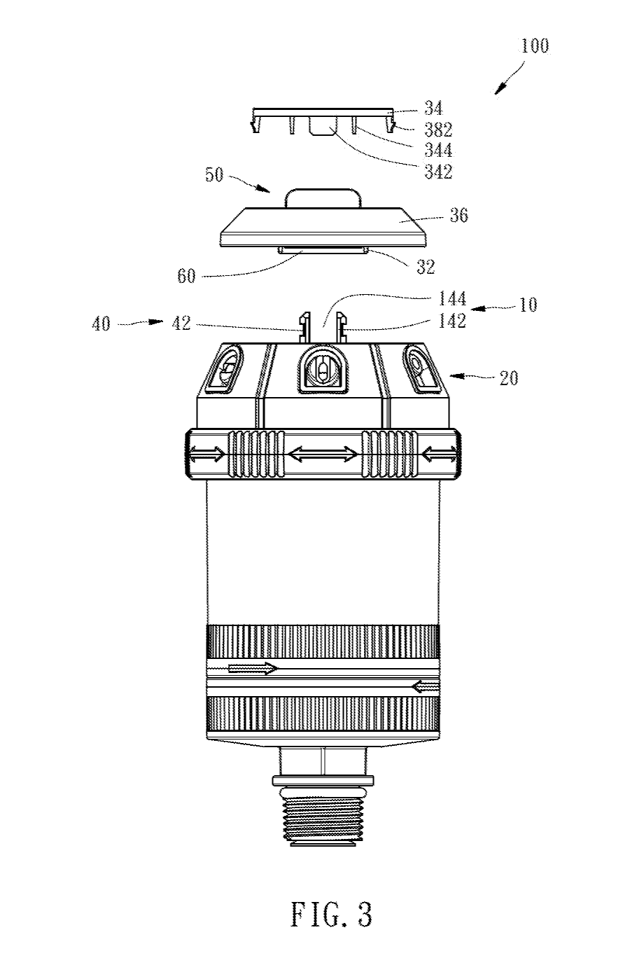

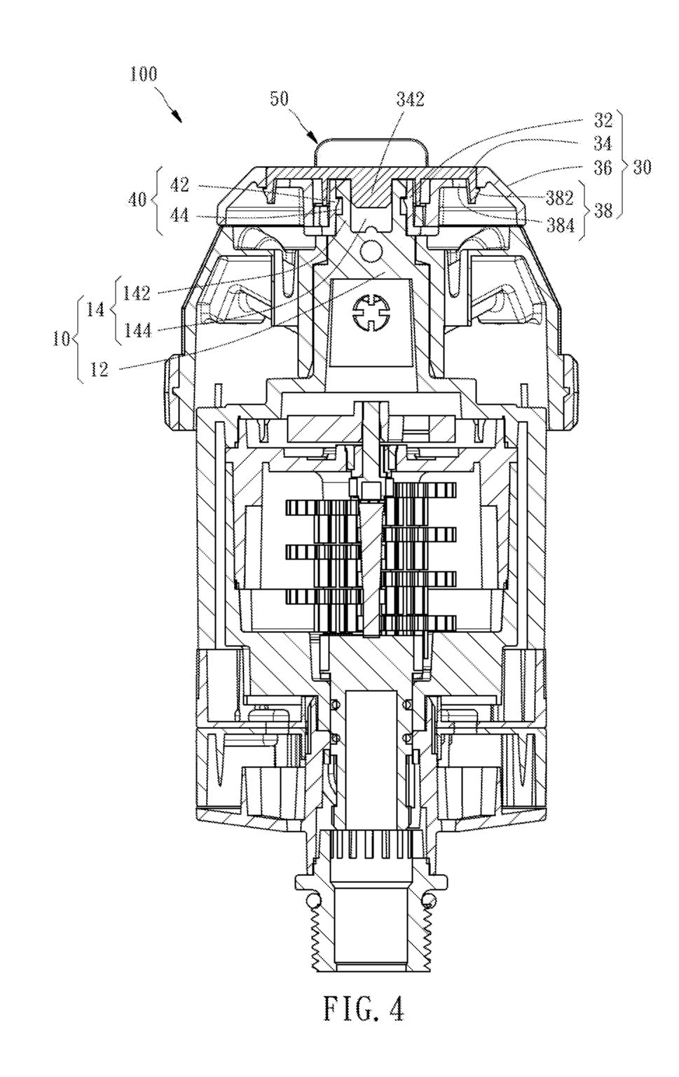

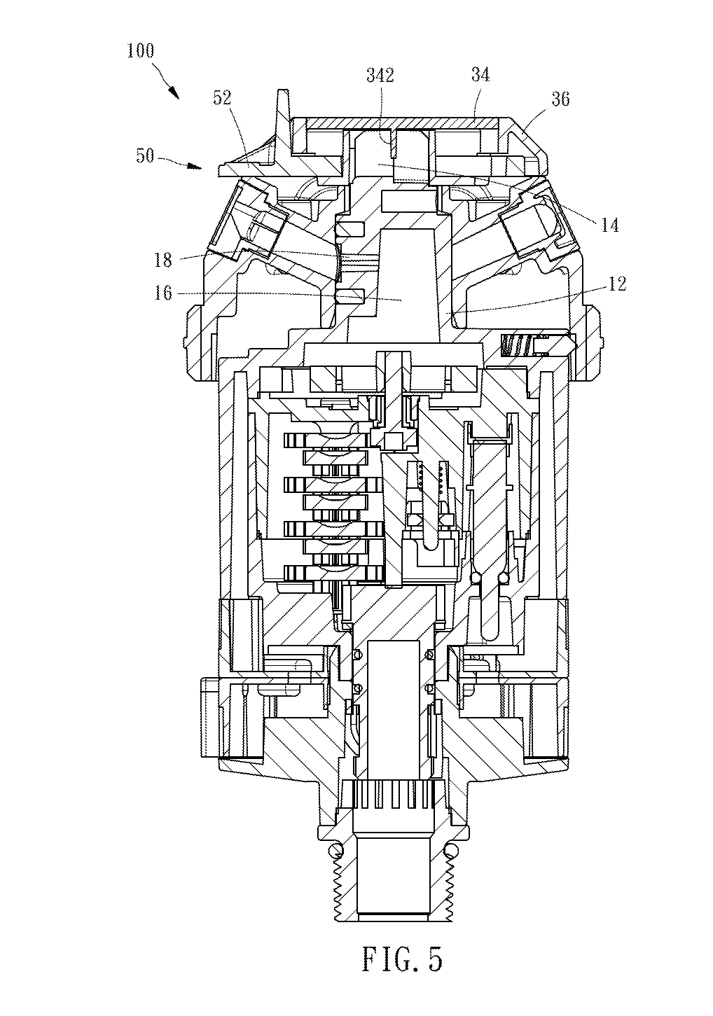

FIGS. 1 through 5 pertain to a first embodiment of the present disclosure. The irrigation sprinkler 100 includes a base 10, a nozzle assembly 20, a cap component 30, a first engagement component 40, and an indication component 50.

The base 10 includes a foundation member 12, and a holding member 14 disposed on the foundation member 12; the base 10 defines an outlet channel 16 formed in the foundation member 12 and communicating with the water source, and an orifice 18 formed on the foundation member 12 and communicating with the outlet channel 16.

The nozzle assembly 20 slidably attaches to the base 10 and is capable of rotating around a generally vertical axis of the base 10. The nozzle assembly 20 defines a housing 21, a passage 22 formed through the housing 21, and a plurality of nozzles 24 circumferentially arranged on the housing 21 and spaced apart. Usually, the nozzles 24 are set around the generally vertical axis of the base 10, and could be integrally made with the housing 21 or be individually arranged in the housing 21. The holding member 14 of the base 10 penetrates the passage 22 of the housing 21. The nozzles 24 offer various spray patterns.

The cap component 30 sits over the base 10 and the nozzle assembly 20. The cap component 30 includes an anchor member 32 disposed on a bottom exterior thereof in order to correspond to the holding member 14 of the base 10.

The first engagement component 40 includes a first male member 42 and a first female member 44 mating with each other. The first male member 42 is alternatively arranged on the holding member 14 of the base 10 and the anchor member 32 of the cap component 30, and the first female member 44 is arranged on the other. The first male member 42 non-releasably couples with the first female member 44 so that the first engagement component 40 connects the cap component 30 to the base 10. More specifically, the first male member 42 non-releasably couples with the first female member 44 by a converging movement between the holding member 14 and the anchor member 32. The nozzle assembly 20 is consequently restrained between the cap component 30 and the base 10.

The indication component 50 couples with the cap component 30 and corresponds to the orifice 18 of the base 10. A rotation of the nozzle assembly 20 enables the indication component 50 to align with a selected one of the nozzles 24, which is chosen to communicate with the orifice 18 of the base 10, the indication component 50 consequently offers visual recognition of the selected one of the nozzles 24.

A reception 60 is arranged on the anchor member 32 of the cap component 30 for accommodating the holding member 14 of the base 10.

Further in detail, the cap component 30 includes a lid 34, a retainer cover 36, and a second engagement component 38 coupling the lid 34 to the retainer cover 36. The second engagement component 38 includes two male clips 382 arranged to and beneath the lid 34, and two female slits 384 arranged on the retainer cover 36 mated with the two male clips 382 respectively. The anchor member 32 is arranged on the retainer cover 36. Since the first engagement component 40 connects the anchor member 32 to the holding member 14, both of the lid 34 and the retainer cover 36 of the cap component 30 are non-releasable to the base 10 in this case.

Further in detail, the holding member 14 of the base 10 includes two resilient plates 142 opposite to each other and corresponding to the anchor member 32, and a gap 144 formed between the two resilient plates 142. The first female member 44 is a recessed groove arranged on each of the two resilient plates 142, and the first male member 42 is a pair of protruded bulges arranged on the anchor member 32. The first engagement component 40 connects the resilient plates 142 of the holding member 14 to the retainer cover 36. A wall 342 and two opposite abutting plates 344 extend from bottom of the lid 34. The wall 342 reaches into the gap 144 of the holding member, thereby pressing the two resilient plates 142 against the anchor member 32.

Further in detail, the retainer cover 36 defines a slot 362 formed transversely thereof and corresponding to the orifice 18 of the base 10. The indication component 50 defines a slide tab 52, and an opening 54 formed on the slide tab 52. The slide tab 52 glides within the slot 362 of the retainer cover 36; the two abutting plates 344 of the lid 34 retain the slide tab 52 in the slot 362. The anchor member 32 travels within the opening 54 while the slide tab 52 glides; it thereby prevents the slide tab 52 from completely gliding out of the slot 362 and becomes loose. The slide tab 52 itself not only functions as means of adjusting the water spray, but also offers the recognition of the spray direction of the sprinkler 100.

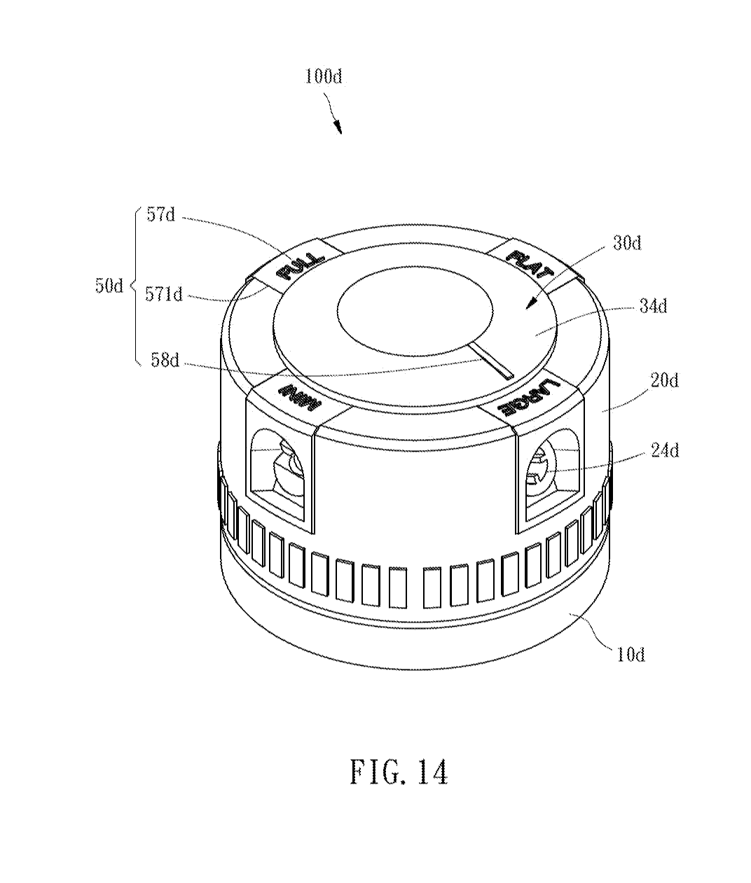

In an alternative embodiment (not illustrated), the cap component 30 is one-piece and defines a slot, and the slide tab defines two resilient tabs which pass through the slot and retains the slide tab in place. Refer to FIG. 14 of U.S. Pat. No. 7,255,291 for more details.

### Second Embodiment

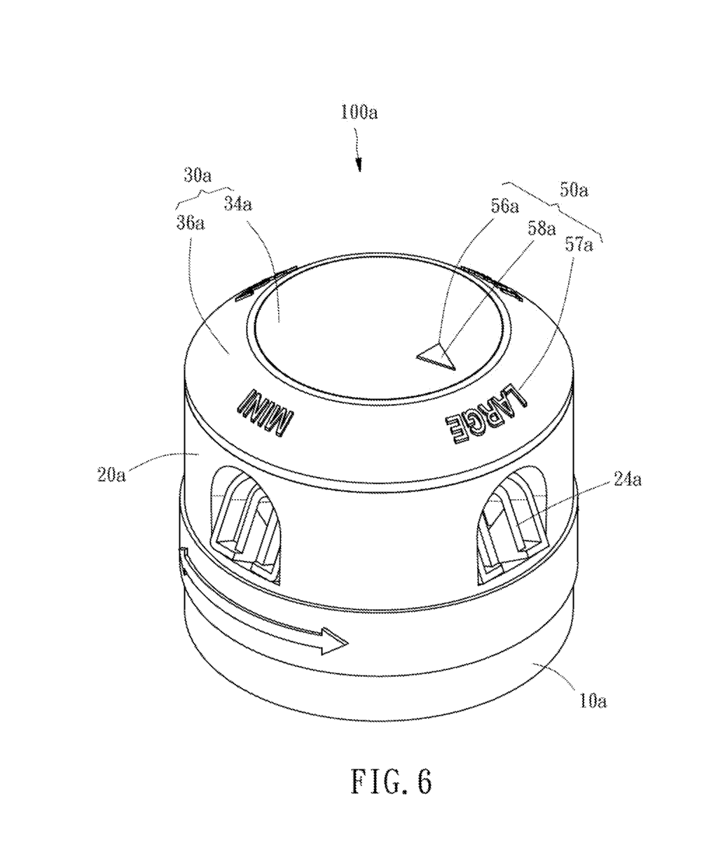

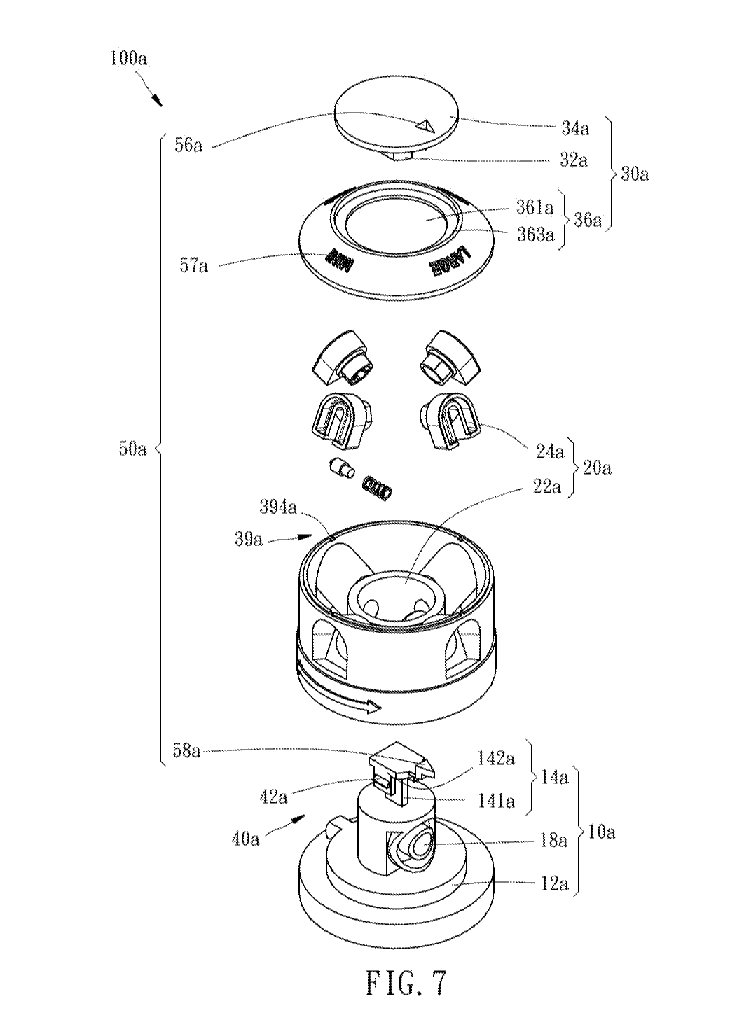

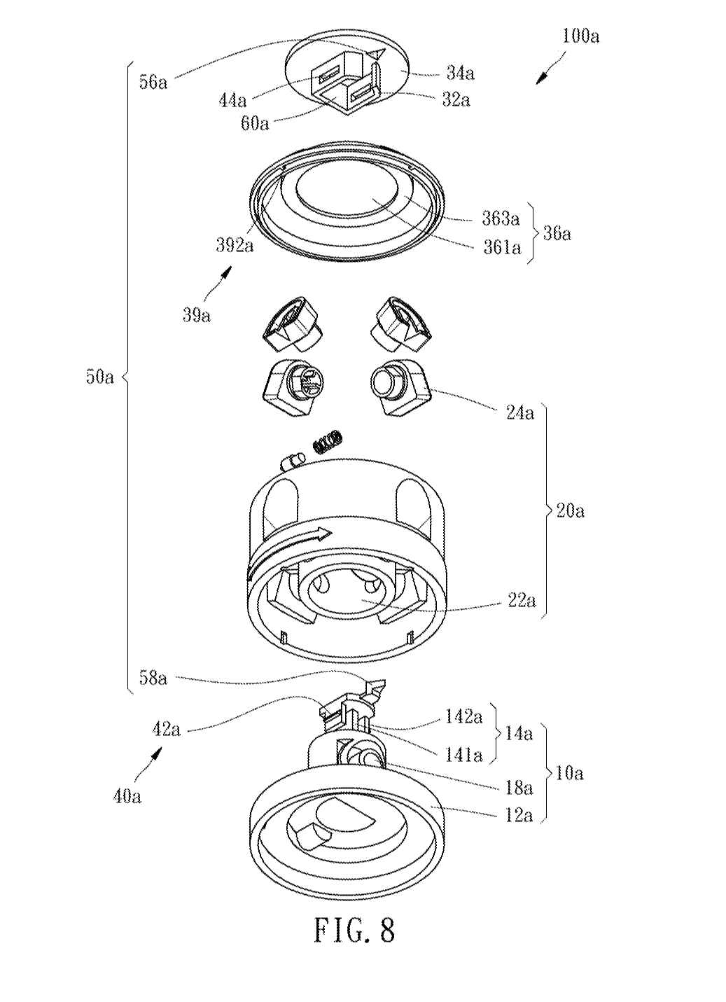

FIGS. 6 to 8 pertain to a second embodiment of the present disclosure. The irrigation sprinkler 100a includes a base 10a, a nozzle assembly 20a, a cap component 30a, a first engagement component 40a, and an indication component 50a.

The base 10a includes a foundation member 12a, and a holding member 14a disposed on the foundation member 12a; the base 10a defines an outlet channel (not illustrated) formed in the foundation member 12a and communicating with the water source, and an orifice 18a formed on the foundation member 12a and communicating with the outlet channel.

The nozzle assembly 20a slideably attaches to the base 10a and is capable of rotating around a generally vertical axis of the base 10a. The nozzle assembly 20a defines a passage 22a formed therein and a plurality of nozzles 24a circumferentially arranged thereof and spaced apart. The holding member 14a of the base 10a penetrates the passage 22a of the nozzle assembly 20a. The nozzles 24a offer various spray patterns.

The cap component 30a sits over the base 10a and the nozzle assembly 20a. The cap component 30a includes an anchor member 32a, a lid 34a, a retainer cover 36a, and a third engagement component 39a coupling the retainer cover 36a to the nozzle assembly 20a. The retainer cover 36a is relatively movable to the lid 34a. The retainer cover 36a is non-rotatable to the nozzle assembly 20a because the third engagement component 39a connects the retainer cover 36a to the nozzle assembly 20a.

In this case, the anchor member 32a disposes on a bottom of the lid 34a and corresponds to the holding member 14a of the base 10a.

The third engagement component 39a includes at least one third male member 392a arranged on the retainer cover 36a, and at least one third female member 394a arranged on the nozzle assembly 20a and mating with third male member 392a. The retainer cover 36a is non-rotatable to the nozzle assembly 20a because the third engagement component 39a connects the retainer cover 36a to the nozzle assembly 20a. The third engagement component 39a does not refer to the character of the present disclosure and may not be restrained by structure mentioned above.

The first engagement component 40a includes a first male member 42a and a first female member 44a mating with each other. The first male member 42a non-releasably couples with the first female member 44a by a converging movement of the holding member 14a and the anchor member 32a toward each other, so that the first engagement component 40a connects the cap component 30a to the base 10a. The nozzle assembly 20a is consequently restrained after the converging movement by the cap component 30a and the base 10a.

The indication component 50a includes a sign window 56a and a sign portion 58a corresponding with each other; the sign window 56a is formed on the lid 34a of the cap component 30a and aligns with the orifice 18a of the base 10a. The sign portion 58a extends from the holding member 14a of the base 10a toward the lid 34a of the component 30a for fitting in the sign window 34a of the cap component 30a; the sign portion 58a sequentially is visible on the cap component 30a. Furthermore, the indication component 50a includes a plurality of marks 57a set on the retainer cover 36a and respectively coincided with the nozzles 24a; the sign portion 58a is capable of pointing out a selected one of the marks 57a after the retainer cover 36a synchronously rotates with the nozzle assembly 20a.

A reception 60a is arranged on the anchor member 32a of the cap component 30a for accommodating the holding member 14a of the base 10a.

Further in detail, the holding member 14a of the base 10a includes a T-shaped pillar 141a, and two opposing resilient plates 142a extend from two lateral sides of the T-shaped pillar 141a and parallel with each other. The first male member 42a is a clip tab arranged on each of the two resilient plates 142a, and the first female member 44a is a pair of mounting holes arranged on the anchor member 32a. The first engagement component 40a connects the resilient plates 142a of the holding member 14a to the lid 34a while the clip tab fits in the mounting hole.

Further in detail, the retainer cover 36a has an opening 361a and an interior stage 363a. The lid 34a sits on the interior stage 363a of the retainer cover 36a.

In an alternative embodiment (not illustrated), the first female member 44a is a mounting hole arranged on each of the two resilient plates 142a of the holding member 14a of the base 10a, and the first male member 42a is a pair of clip tabs arranged on the anchor member 32a of the cap component 30a.

In an alternative embodiment (not illustrated), the third engagement component include a plurality of male members disposed on the retainer cover 36a, and at least one male member disposed on the nozzle assembly 20a, wherein the plurality of male members define at least one space, and the at least one male member is retained in the space.

### Third Embodiment

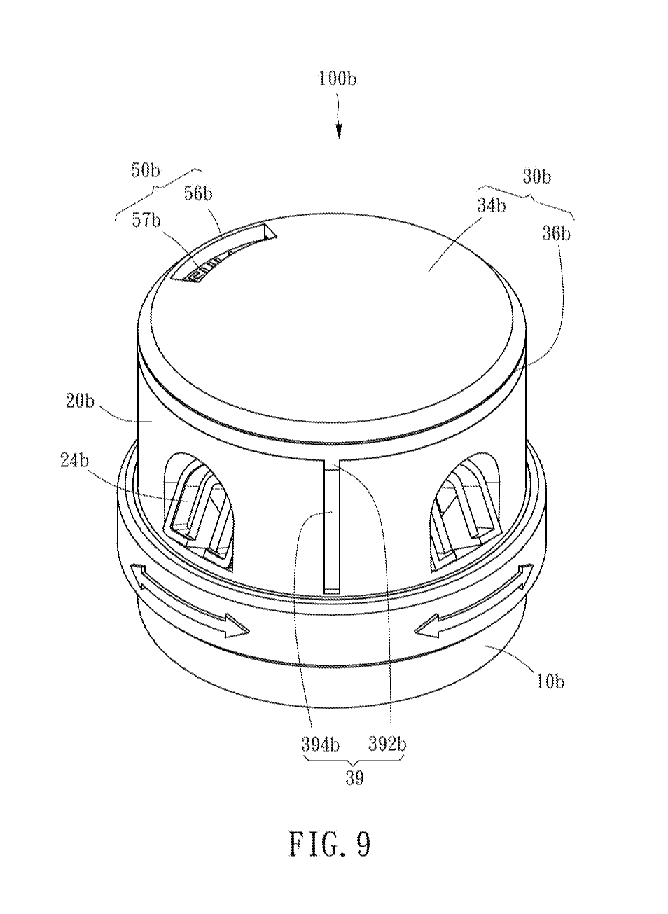

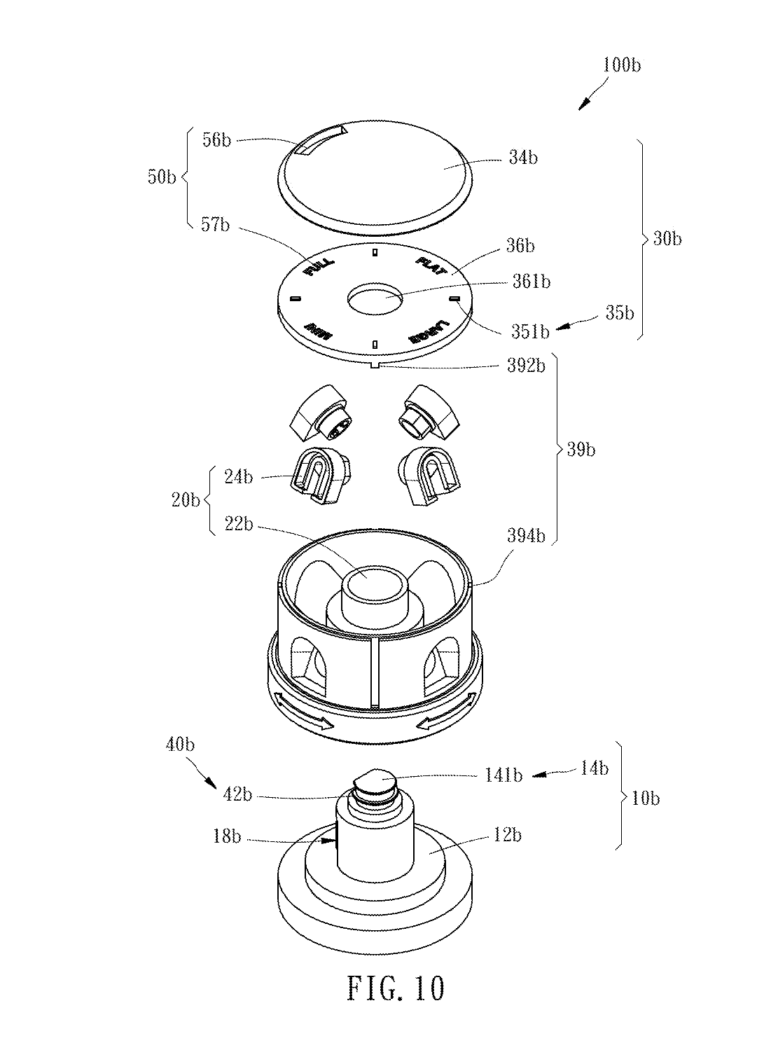

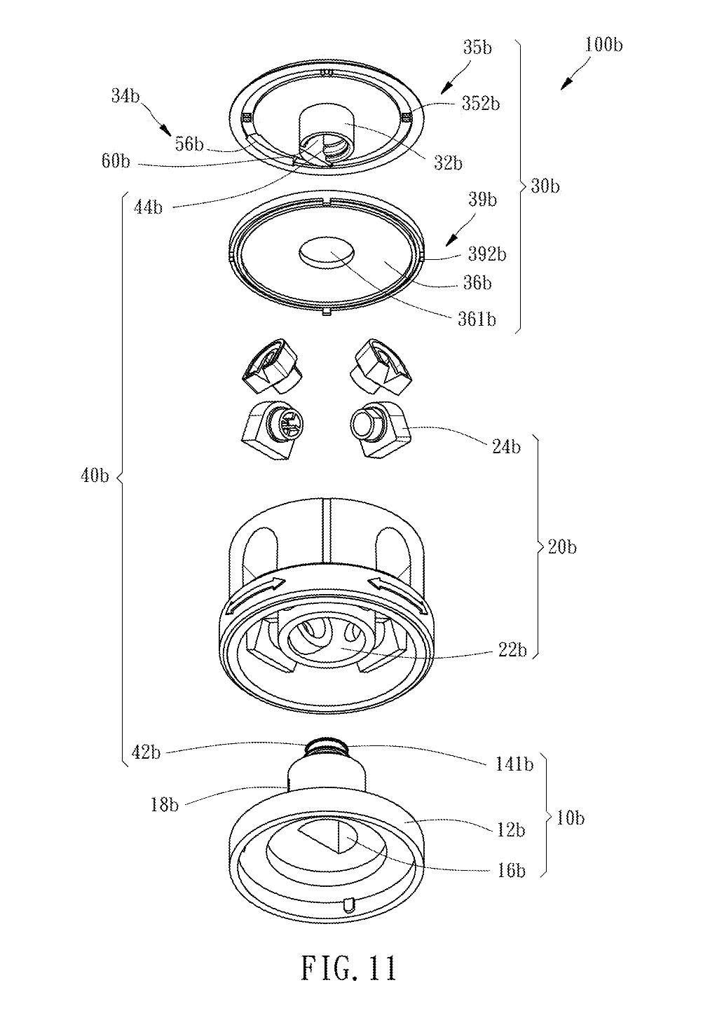

FIGS. 9 to 11 pertain to a third embodiment of the present disclosure, which is similar to the second embodiment in that it includes a base 10b, a nozzle assembly 20b, a cap component 30b, a first engagement component 40b, and an indication component 50b.

The base 10b has a foundation member 12b, and a holding member 14b disposed on the foundation member 12b. In this case, the holding member 14b includes a pillar 141b having a non-circular cross-section.

The nozzle assembly 20b defines a plurality of nozzles 24b.

The cap component 30b sits over the base 10b and the nozzle assembly 20b. The cap component 30b includes a lid 34b, an anchor member 32b disposes on the lid 34b, a retainer cover 36b, and a third engagement component 39b coupling the retainer cover 36b to the nozzle assembly 20b. The retainer cover 36b is relatively movable to the lid 34b, and has an opening 361b. The lid 34b sits upon the retainer cover 36b.

A reception 60b is arranged on the anchor member 32b of the cap component 30b, and being contoured as same as the pillar 141b, so that the anchor member 32b of the cap component 30b fits with the pillar 141b of the holding member 14b of the base 10b.

The first engagement component 40b includes a first male member 42b and a first female member 44b mating with each other. The first male member 42b is a protruded bulge arranged on the pillar 141b of the holding member 14b of the base 10b, and the first female member 44b is a recessed groove arranged on the anchor member 32b of the cap component 30b. The first engagement component 40b connects the pillar 141b of the holding member 14b to the lid 34b of the cap component 30b via a converging movement by the holding member 14b toward the anchor member 32b.

The indication component 50b includes a sign window 56b and a plurality of marks 57b. The sign window 56b is formed on the lid 34b of the cap component 30b and aligns with an orifice 18b disposed on the base 10b. The marks 57b are set on the retainer cover 36b and respectively coincided with the nozzles 24b; the sign window 56b is capable of revealing a selected one of the marks 57b after the retainer cover 36b synchronously rotates with the nozzle assembly 20b.

Further in detail, the cap component 30b includes positioning means 35b. The positioning means 35b includes at least one bump 35 lb set on a top exterior of the retainer cover 36b and at least one positioning rail 352b formed on the bottom exterior of the lid 34b. The positioning rail 352b defines a plurality of notches for retaining the bump 351b.

### Fourth Embodiment

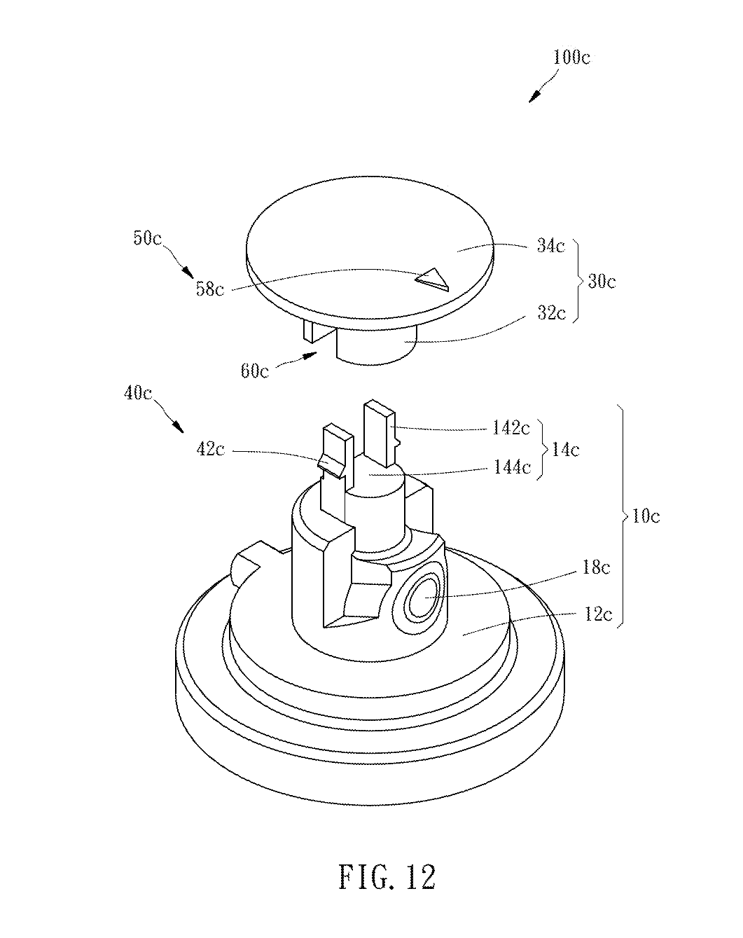

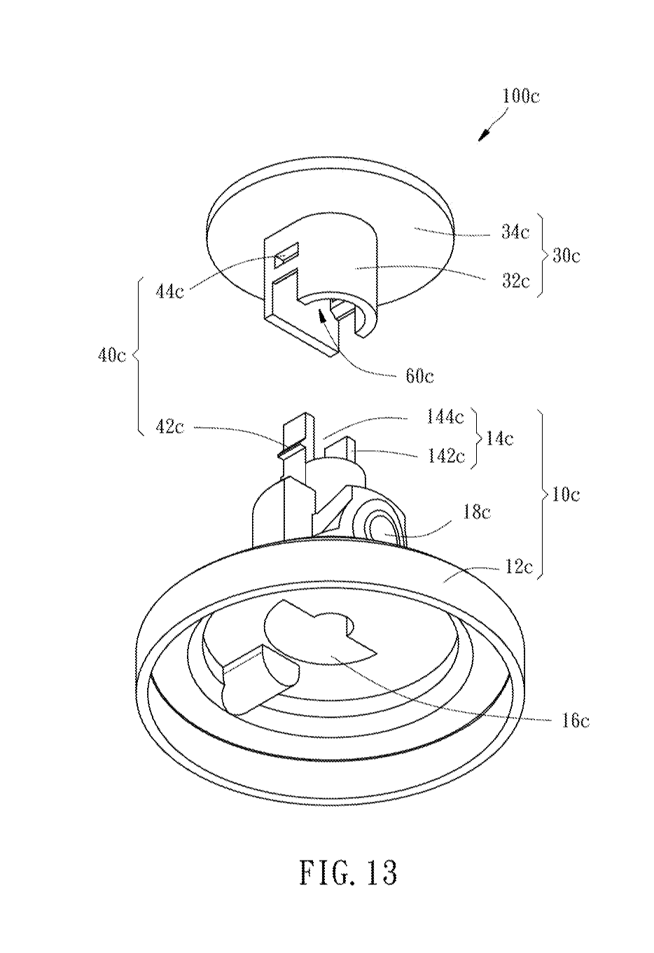

FIGS. 12 and 13 pertain to a fourth embodiment of the present disclosure, which is similar to the second embodiment in that it includes a base 10c, a nozzle assembly (not illustrated), a cap component 30c having an anchor member 32c, a lid 34c and a retainer cover (not illustrated), a first engagement component 40c, an indication component 50c. In the base 10c, a holding member 14c disposes on a foundation member 12c, in which an outlet channel 16 and an orifice 18 communicates with each other. In the cap component 30c, the anchor member 32c disposes on the lid 34c. A third engagement component (not illustrated) connects the retainer cover to the nozzle assembly.

In this case, the holding member 14c includes two resilient plates 142c opposite to each other and a gap 144c formed between the interior sides of the two resilient plates 142c.

The first engagement component 40c includes a first male member 42c and a first female member 44c mating with each other. The first male member 42c is a clip tab arranged on an exterior side of each of the resilient plates 142c, and the first female member 44c is a pair of mounting holes arranged on the anchor member 32c. The first engagement component 40c connects the resilient plates 142c of the holding member 14c to the lid 34c of the cap component 30c by a converging movement between the holding member 14c and the anchor member 32c.

The indication component 50c includes a sign portion 58c aligning with an orifice 18c of the base 10c; the indication component 50c could be slightly bulged on the lid 34c for visual recognition.

A reception 60c is arranged on the anchor member 32c of the cap component 30c for accommodating the holding member 14c of the base 10c.

In an alternative embodiment (not illustrated), the first male member 42c of the first engagement component 40c is arranged on an interior side each of the resilient plates 142c, in which case the reception 60c is arranged on the holding member 14c of for accommodating the anchor member 32c.

### Fifth Embodiment

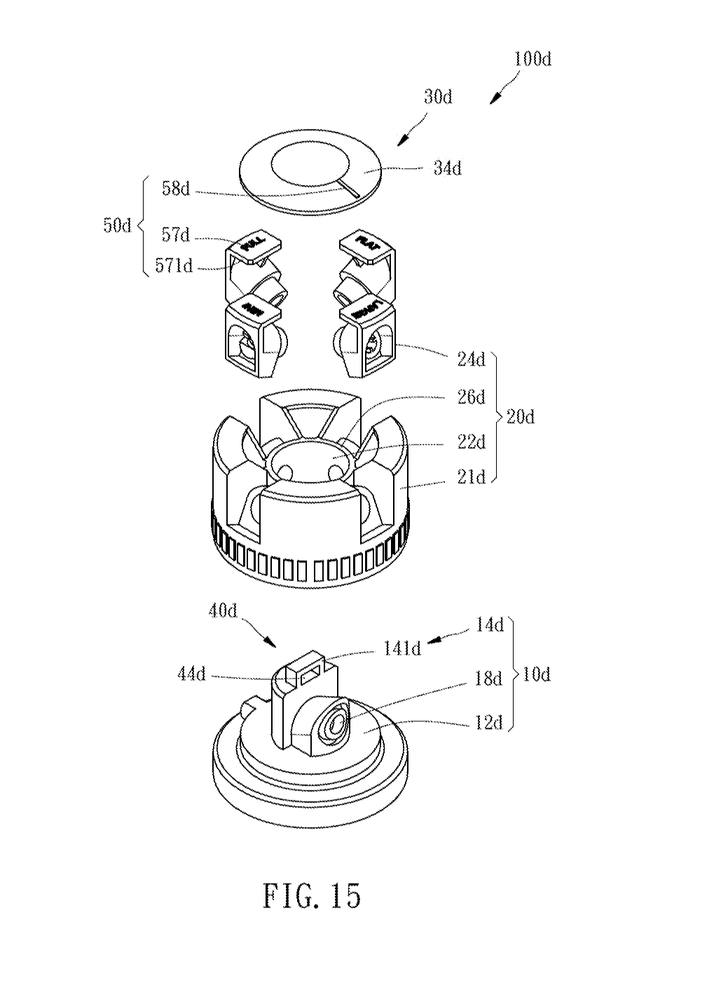

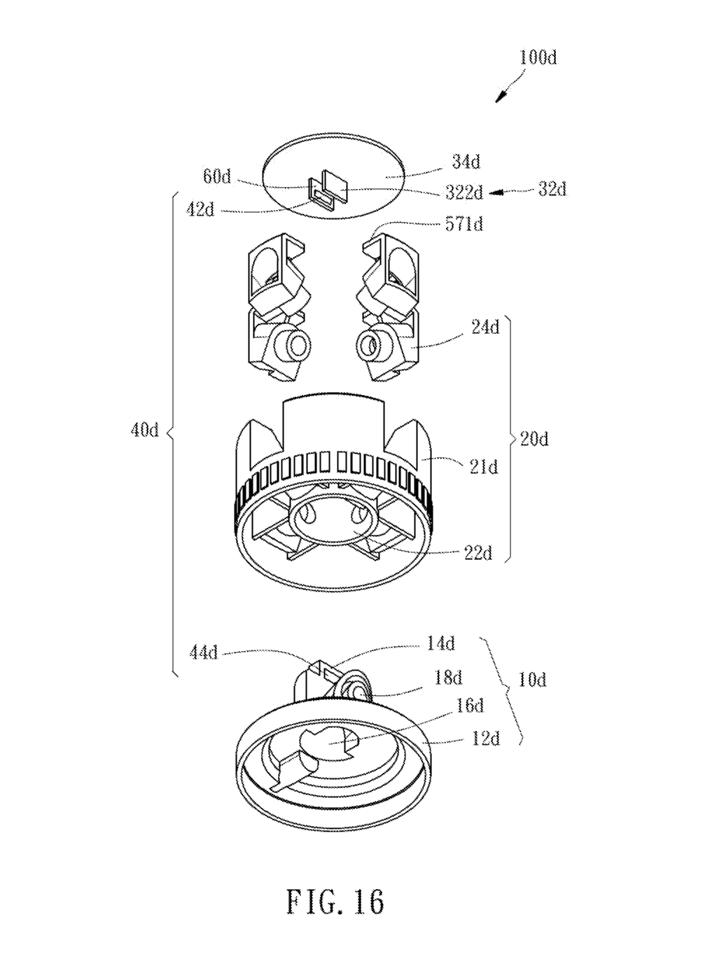

FIGS. 14 to 16 pertain to a fifth embodiment of the present disclosure. The irrigation sprinkler 100d includes a base 10d, a nozzle assembly 20d, a cap component 30d, a first engagement component 40d, and an indication component 50d.

The base 10d includes a foundation member 12d, and a holding member 14d disposed on the foundation member 12d; the base 10d defines an outlet channel 16d formed in the foundation member 12d and communicating with the water source, and an orifice 18d formed on the foundation member 12d and communicating with the outlet channel 16d.

The nozzle assembly 20d slidably attaches to the base 10d and is capable of rotating around a generally vertical axis of the base 10d. The nozzle assembly 20d includes a housing 21d defining a top, a passage 22d formed through the housing 21d, and a plurality of nozzles 24d circumferentially arranged in the housing 21d and spaced apart. The holding member 14d of the base 10d penetrates the passage 22d of the nozzle assembly 20d. The nozzles 24d offer various spray patterns.

The cap component 30d sits over the base 10d and the nozzle assembly 20d. The cap component 30d includes a lid 34d, and an anchor member 32d disposed on the lid 34d.

The first engagement component 40d includes a first male member 42d and a first female member 44d mating with each other. The first male member 42d non-releasably couples with the first female member 44d by a converging movement between the holding member 14d and the anchor member 32d, so that the first engagement component 40d connects the cap component 30d to the base 10d. The nozzle assembly 20d is consequently restrained between the cap component 30d and the base 10d after the converging movement.

The indication component 50d includes a sign portion 58d arranged on the lid 34d of the cap component 30d and aligns with the orifice 18d of the base 10d. The sign portion 58d could be further recessed or bulged in option, and sequentially could be visible on the cap component 30d. In the case, the sign portion 58d is a strip-like bulge. Furthermore, the indication component 50d includes a plurality of marks 57d set on the nozzle assembly 20d and respectively coincided with the nozzles 24d. In addition, the indication component 50d includes a plurality of tabs 571d respectively coinciding with the nozzles 24d. The sign portion 58d is capable of pointing out a selected one of the marks 57d after the nozzle assembly 20d rotates.

Further in detail, the holding member 14d includes a pillar 141d. The anchor member 32d includes two resilient plates 322d opposite to each other. The first male member 42d is a clip tab arranged on an interior of each of the two resilient plates 322d of the anchor member 32d, and the first female member 44d is a mounting hole arranged through the pillar 141d of the holding member 14d.

Further in detail, a reception 60d is formed between the two resilient plates 322d of the anchor member 32d for accommodating the holding member 14 of the base 10.

In an alternative embodiment (not illustrated), each of the tabs 571d is formed without mark 57d and is substantially embedded on an exterior of the nozzle assembly 20d. The tabs 571d are variously colored for visual recognition on a selected one of the nozzles 24d.

In an alternative embodiment (not illustrated), the sign portion 58d could be replaced by a window, which is capable of revealing a selected one of the marks 57d after the nozzle assembly 20d rotates.

Therefore, the irrigation sprinkler in the present disclosure offers convenient assembly without screws. Instead of screws, two parts of the first engagement component are respectively arranged on the cap component and the base, and the first engagement component connects the cap component to the base by a converging movement. The irrigation sprinkler further provides easy manipulation for users fully grasping the irrigation sprinkler from top to rotate the nozzle assembly. The irrigation sprinkler further provides visual identification for the users to recognize the selected nozzle and the spray direction.

The preceding description is meant to be illustrative of preferred embodiments and should not be construed as limiting the scope of the present disclosure. Various modifications, which would be readily apparent to one skilled in the art, are intended to be within the scope of the present disclosure. Accordingly, the only limitations to the scope of the present disclosure are set forth in the following claims appended hereto.

What is claimed is:

1. An irrigation sprinkler, adapted for connecting to a water source, comprising:
a base defining an orifice communicating with the water source, and including a holding member disposed thereon;
a nozzle assembly slidably attaching to the base and being capable of rotating around a generally vertical axis of the base; the nozzle assembly defining a plurality of nozzles circumferentially arranged thereof and spaced apart; the nozzle assembly further defining a passage through which the holding member of the base penetrates;
a cap component sitting over the base and the nozzle assembly; the cap component having an anchor member corresponding to the holding member of the base;
a first engagement component including a first male member and a first female member; the first male member being alternatively arranged on the holding member of the base and the anchor member of the cap component, and the first female member being arranged on the other; wherein the first male member non-releasably couples with the first female member by converging movement between the holding member and the anchor member, and the first engagement component connects the cap component to the base; wherein the nozzle assembly is restrained between the cap component and the base; and
an indication component coupling with the cap component and corresponding to the orifice of the base; whereby a rotation of the nozzle assembly enables the indication component to align with a selected one of the nozzles, which communicates with the orifice of the base, and offers visual recognition of the selected one of the nozzles.

2. The irrigation sprinkler as claimed in claim 1, wherein the cap component includes a slot; the indication component defines a slide tab; the slide tab glides within the slot.

3. The irrigation sprinkler as claimed in claim 2, wherein the cap component includes a lid, a retainer cover, and a second engagement component coupling the lid to the retainer cover;
the anchor member arranged in the retainer cover, and both of the lid and the retainer cover of the cap component are non-releasable to the base;
the slot is formed transversely on the retainer cover;
whereby the slide tab glides within the slot of the retainer cover, and the anchor member travels within the opening while the slide tab glides.

4. The irrigation sprinkler as claimed in claim 1, wherein the cap component includes a lid and a retainer cover relatively movable to each other; the retainer cover is non-releasable to the nozzle assembly; the anchor member is arranged on the lid.

5. The irrigation sprinkler as claimed in claim 1, wherein the cap component includes a lid, a retainer cover arranged between the lid and the nozzle assembly, and a third engagement component connecting the retainer cover to the nozzle assembly;
the third engagement component includes at least one third male member and at least one third female member; the third male member is alternatively arranged on the retainer cover and the nozzle assembly, and the third female member is arranged on the other; the retainer cover is non-rotatable to the nozzle assembly, and relatively rotatable to the lid;
the anchor member arranged on the lid, and the lid of the cap component is non-releasable to the base.

6. The irrigation sprinkler as claimed in claim 4, wherein the indication component includes a sign window and a sign portion corresponding with each other;
the sign window is formed on the lid of the cap component and aligns with the orifice of the base; the sign portion extends from the holding member of the base toward the lid of the component for fitting in the sign window.

7. The irrigation sprinkler as claimed in claim 6, wherein the indication component includes a plurality of marks set on the retainer cover and respectively coincided with the nozzles; the sign portion is capable of pointing out a selected one of the marks after the retainer cover synchronously rotates with the nozzle assembly.

8. The irrigation sprinkler as claimed in claim 4, wherein the indication component includes a sign window and a plurality of marks; the sign window is formed on the lid of the cap component and aligns with the orifice of the base; the marks are set on the retainer cover beneath the lid and respectively coincided with the nozzles; the sign window is capable of revealing a selected one of the marks after the retainer cover synchronously rotates with the nozzle assembly.

9. The irrigation sprinkler as claimed in claim 4, wherein the indication component includes a sign portion arranged on the lid of the cap component and aligned with the orifice of the base, and a plurality of marks set on the retainer cover and respectively coincided with the nozzles.

10. The irrigation sprinkler as claimed in claim 1, wherein the indication component includes a sign portion arranged on an exterior of the cap component and aligned with the orifice of the base.

11. The irrigation sprinkler as claimed in claim 10, wherein the indication component includes a plurality of marks set upon the nozzle assembly and respectively coincided with the nozzles; the sign portion is capable of pointing out a selected one of the marks after the nozzle assembly rotates.

12. The irrigation sprinkler as claimed in claim 10, wherein the nozzle assembly includes a housing defining a top; the passage is formed through the housing, the nozzles are circumferentially arranged in the housing; the indication component includes a plurality of tabs respectively coinciding with the nozzles and colored.

13. The irrigation sprinkler as claimed in claim 10, wherein the nozzle assembly includes a housing defining a top; the passage is formed through the housing; the indication component includes a plurality of tabs respectively coinciding with the nozzles, and a plurality of marks respectively set on the tabs of the nozzle assembly.

14. The irrigation sprinkler as claimed in claim 1, wherein at least one resilient plate, on which the first male member is arranged, is alternatively arranged on the holding member of the base and the anchor member of the cap component, and the first female member is arranged on the other.

15. The irrigation sprinkler as claimed in claim 1, wherein at least one resilient plate, on which the first female member is arranged, is alternatively arranged on the holding member of the base and the anchor member of the cap component, and the first male member is arranged on the other.

16. The irrigation sprinkler as claimed in claim 1, wherein the first male member is a bulge, and the first female member is a recess.

17. The irrigation sprinkler as claimed in claim 1, further including a reception alternatively arranged on the holding member of the base and the anchor member of the cap component, for accommodating the other.
